(19) United States
(12) Patent Application Publication
(10) Pub. No.: US 2024/0281842 A1
(43) Pub. Date: Aug. 22, 2024

(54) INFORMATION PROCESSING DEVICE

(71) Applicant: TOYOTA JIDOSHA KABUSHIKI KAISHA, Toyota-shi (JP)

(72) Inventors: Jumpei TANAKA, Tokyo (JP); Liming Yang, Tokyo (JP); Feng Xu, Yokohama-shi (JP); Hitoshi Kageyama, Tokyo (JP)

(73) Assignee: TOYOTA JIDOSHA KABUSHIKI KAISHA, Toyota-shi (JP)

(21) Appl. No.: 18/442,479

(22) Filed: Feb. 15, 2024

(30) Foreign Application Priority Data
Feb. 20, 2023 (JP) 2023-024602

(51) Int. Cl. G06Q 30/0207; G06F 16/955

(52) U.S. Cl. CPC G06Q 30/0222; G06F 16/9566

(57) ABSTRACT

A digital coupon system (information processing device) consists of a database in which information on business operators and information on services provided by business operators are stored in association with each of a plurality of business operators, and a processor (control unit). When receiving a coupon issuance request from an Italian business division (a first business operator) that specifies a Thai business division (a second business operator) and a car sharing service (a second service) as a coupon issuance target related to a car lease service (a first service), the processor performs control to send a coupon to a user associated with the issuance target.

### CROSS-REFERENCE TO RELATED APPLICATION

This application claims priority to Japanese Patent Application No. 2023-024602 filed on Feb. 20, 2023 incorporated herein by reference in its entirety.

### BACKGROUND

### 1. Technical Field

The present disclosure relates to an information processing device.

### 2. Description of Related Art

Japanese Unexamined Patent Application Publication No. 2020-140511 (JP 2020-140511 A) discloses a system in which when a user of a locker in a department store approaches a store device in the department store after storing luggage in the locker, a privilege that can be used in the store is given to the user.

### SUMMARY

Here, among business operators providing predetermined services, it is desired to promote mutual use of services by users associated with each of the business operators. For the promotion, it is conceivable to issue coupons across business operators. However, in this case, each time a coupon is issued, cooperative processing such as connecting the systems of business operators is required, which complicates the processing. Therefore, it is desired to simplify the process of issuing coupons across business operators.

The present disclosure has been made to solve the above issue, and the purpose of the present disclosure is to provide an information processing device capable of simplifying the process of issuing coupons across business operators.

According to an aspect of the present disclosure, an information processing device that manages a coupon related to a service provided by each of a plurality of business operators includes: a database that stores, for each of the business operators, information about the business operator and information about the service provided by the business operator in an associated manner; and a control unit that performs control to issue the coupon in response to a coupon issuance request from each of the business operators.

The business operators include a first business operator that provides a first service and a second business operator that provides a second service.

When the control unit receives, from the first business operator, the coupon issuance request that specifies the second business operator and the second service as a coupon issuance target related to the first service, the control unit performs control to issue the coupon related to the first service to a user associated with the issuance target.

In the information processing device according to the aspect of the present disclosure, the control unit issues the coupon related to the first service to the user associated with the second business operator and the second service specified as the coupon issuance target. Accordingly, it is possible to intervene (coordinate) between the business operators with the information processing device when issuing coupons across the business operators. As a result, there is no need to directly connect the system of a coupon issuer and the system of a coupon issuance target. This makes it possible to simplify the process of issuing coupons across business operators.

In the information processing device according to the above aspect, the control unit may perform control to acquire user information about the user, and before issuing the coupon issuance request, perform control to notify the first business operator of the user information.

With this configuration, the first business operator can easily request issuance of a coupon suitable for the user.

In this case, in the information processing device according to the above aspect, each of the business operators may provide a vehicle-related service, and the user information may include either or both of: a taste and preference of the user regarding a vehicle; and a characteristic of the user regarding vehicle driving.

With this configuration, it is possible to issue a coupon that is more suitable for the user based on either or both of: the taste and preference of the user regarding a vehicle; and the characteristic of the user regarding vehicle driving.

In the information processing device according to the above aspect, the control unit may perform control to attach uniform resource locator (URL) information of a website indicating information about the first business operator to the coupon.

With this configuration, the user can easily acquire information about the first business operator that is the issuer of the coupon, when acquiring the coupon.

In the information processing device according to the above aspect, the control unit may perform control to issue the coupon to the user associated with the issuance target when the first business operator and the second business operator are the same.

With this configuration, the first business operator can issue a coupon to the user associated with the first business operator.

According to the present disclosure, it is possible to simplify the process of issuing coupons across business operators.

### BRIEF DESCRIPTION OF THE DRAWINGS

Features, advantages, and technical and industrial significance of exemplary embodiments of the present disclosure will be described below with reference to the accompanying drawings, in which like signs denote like elements, and wherein:

FIG. 1 is a diagram showing the configuration of a digital coupon system according to one embodiment;

FIG. 2 is a diagram illustrating a database of a digital coupon system according to one embodiment;

FIG. 3 is a diagram illustrating control of a digital coupon system according to one embodiment;

FIG. 4 is a diagram showing the relationship between coupon issuers and issuers according to one embodiment;

FIG. 5 is a sequence diagram illustrating control of the digital coupon system according to one embodiment;

FIG. 6 is a diagram showing a website on which coupons are posted according to one embodiment; and

FIG. 7 is a diagram illustrating control of a digital coupon system according to a variation of one embodiment.

### DETAILED DESCRIPTION OF EMBODIMENTS

Hereinafter, an embodiment of the present disclosure will be described in detail with reference to the drawings. In the drawings, the same or corresponding parts are denoted by the same reference signs and the description thereof will not be repeated.

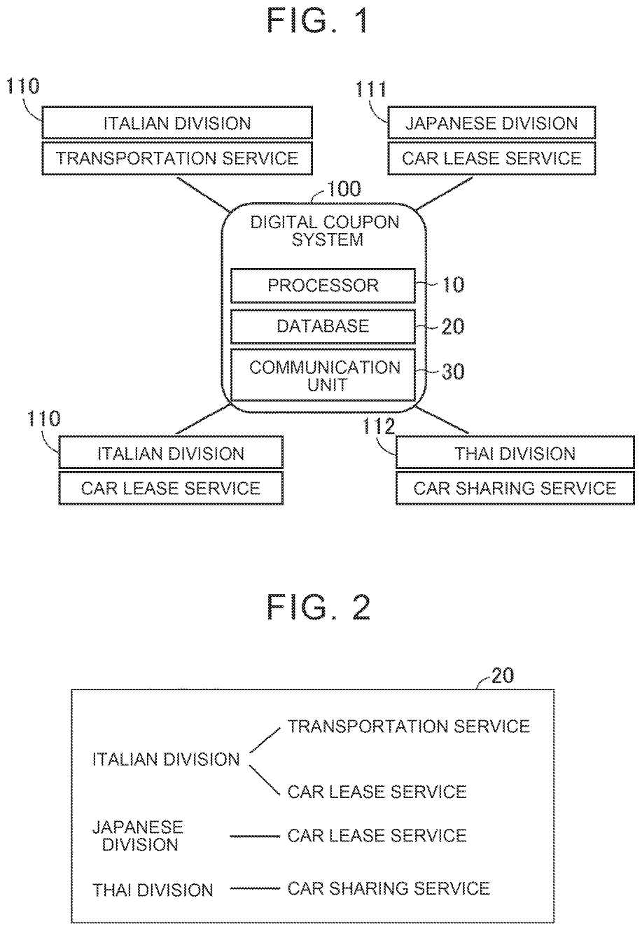

FIG. 1 is a diagram showing the configuration of a digital coupon system 100 according to this embodiment. The digital coupon system 100 manages coupons relating to services provided by each of a plurality of business operators (divisions). In addition, the digital coupon system 100 is an example of the “information processing device” of the present disclosure.

The multiple business operators (divisions) include, for example, an Italian division 110, a Japanese division 111, and a Thai division 112. It should be noted that the Italian division 110 and the Thai division 112 are examples of the “first business operator” and the “second business operator”, respectively, in the present disclosure.

In the example shown in FIG. 1, the Italian division 110 provides a transit service and a car leasing service. The Japanese division 111 also provides a car leasing service. Also, the Thai division 112 provides a car sharing service. Note that the car leasing service and the car sharing service are examples of the “first service” and the “second service” of the present disclosure, respectively.

Digital coupon system 100 includes processor 10, database 20, and communication unit 30. Note that the processor 10 is an example of the “control unit” of the present disclosure.

As used herein, the term “processor” is not limited to processors in the narrow sense that execute processing in a stored program manner, and may include hardwired circuits such as Application Specific Integrated Circuits (ASICs) and Field-Programmable Gate Arrays (FPGAs). As such, the term “processor” may be interchanged with processing circuitry whose operations are pre-defined by computer readable code and/or hardwired circuitry.

As shown in FIG. 2, the database 20 stores information on business divisions and services provided by the business divisions in association with each business division.

Referring to FIG. 1 again, communication unit 30 can communicate with a server (not shown) of each division (110 to 112). Thereby, the communication unit 30 can transmit and receive information to and from each business unit.

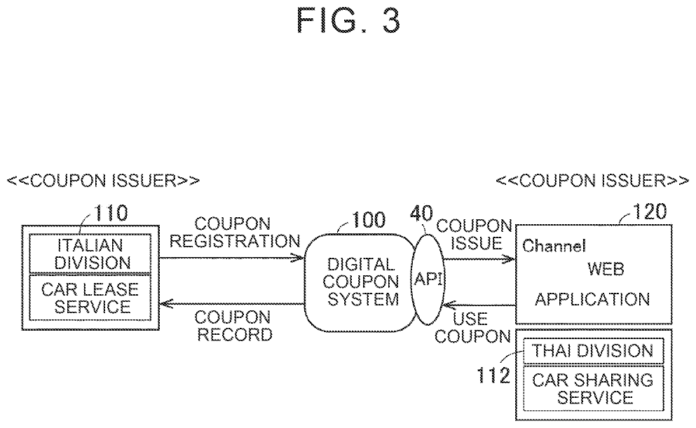

FIG. 3 is a diagram showing an outline of control of the digital coupon system 100. In the example shown in FIG. 3, the Italian division 110, which provides a car leasing service, is the issuer of the coupon. Also, the Thai division 112 that provides the car sharing service is the issue destination of the coupon. In the following, the Italian division 110 that provides the car leasing service may be simply referred to as the “issuer”. Also, the Thai division 112 that provides the car sharing service may be simply referred to as the “issuing party”. Note that the combination of the issuer and the issuer described above is an example, and other combinations may be used. For example, the issuer may be the Japanese division 111 that provides car leasing services. The issuer may be the Italian division 110 that provides car leasing services.

The issuer registers the coupon, for example, on a website or application managed by the digital coupon system 100. Specifically, the issuer specifies (inputs) the business operator of the issuance target and the service along with the contents of the coupon. In the example shown in FIG. 3, the issuer identifies “Thailand Division” and “car sharing service” as the issuer's division and service, respectively. Note that the content of the coupon may be, for example, a discount on the lease fee of the vehicle.

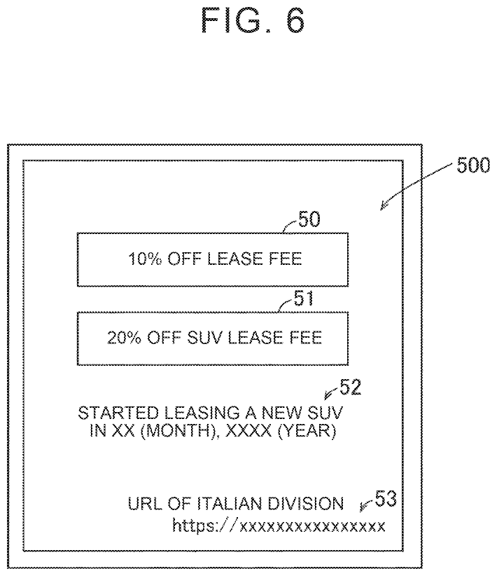

The digital coupon system 100 determines that a coupon issuance request has been made based on the fact that the coupon has been registered. The digital coupon system 100 then issues (distributes) the coupon based on the coupon determined by the issuer and the specified issuer. At this time, the digital coupon system 100 uses the application programming interface (API) 40 to make the coupon 50 and the coupon 51 available on a website or application (for example, see the website 500 in FIG. 6) that can be viewed only by the user associated with the issuer.

As a result, the user associated with the issuer (hereinafter referred to as the issuer user) can use the coupon on the website 500. Coupons on the website 500 are set to be unusable by anyone other than the user to whom they are issued.

Next, the digital coupon system 100 performs control to record that the coupon has been used when the user to whom the coupon is issued has used the coupon on the website 500. For example, the digital coupon system 100 updates the state of the coupon used by the user to the used state on the website managed by the digital coupon system 100, for example. This allows the issuer to recognize that the coupon has been used. Information indicating that the coupon has been used may be transmitted from the digital coupon system 100 to the issuer.

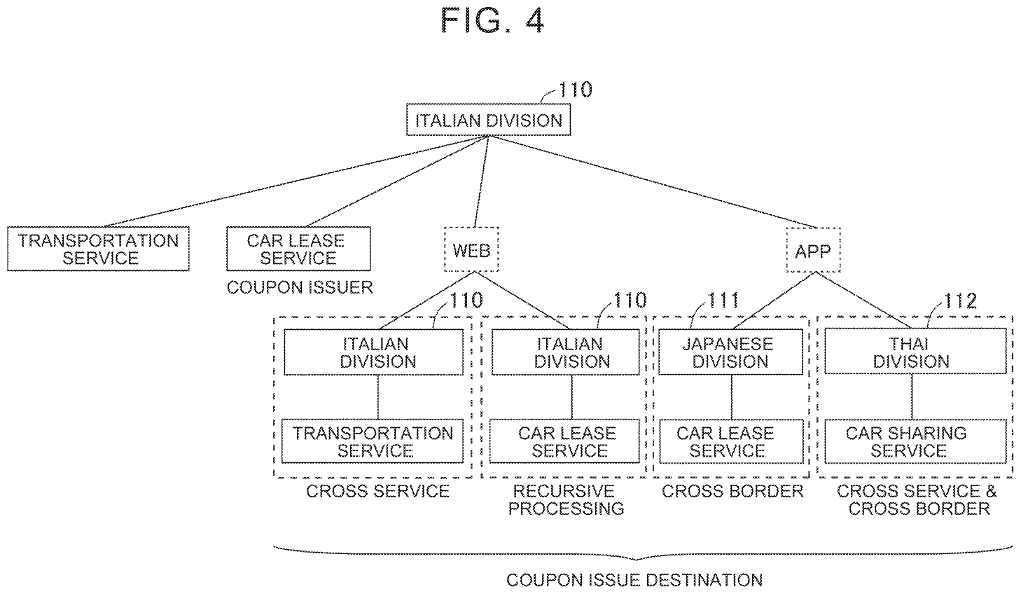

FIG. 4 is a diagram systematically showing coupon issuance control by the digital coupon system 100. The example shown in FIG. 4 is an example in which the Italian division 110 that provides the car leasing service is the issuer of the coupon, similarly to the above.

If the issuer issues a coupon to a user associated with the transportation service of the Italian division 110, the coupon is issued to users associated with the same business unit as the issuer and with a service different from that of the issuer. It corresponds to the “cross service” issued. When the issuer issues a coupon to a user associated with the issuer, the coupon is issued to users who are associated with the same business division as the issuer and the same service as the issuer. It corresponds to the “recursive processing.”

When the issuer issues a coupon to a user associated with the car leasing service of the Japanese division 111, the coupon is issued to users associated with the same service as the issuer and a business division different from the issuer. It corresponds to the “cross-border” issued. When the issuer issues a coupon to a user associated with the car sharing service of the Thai division 112, the coupon is issued to users associated with a service different from the issuer and in a business unit different from the issuer. It corresponds to “cross-service & cross-border”.

### Sequence Control of Digital Coupon System

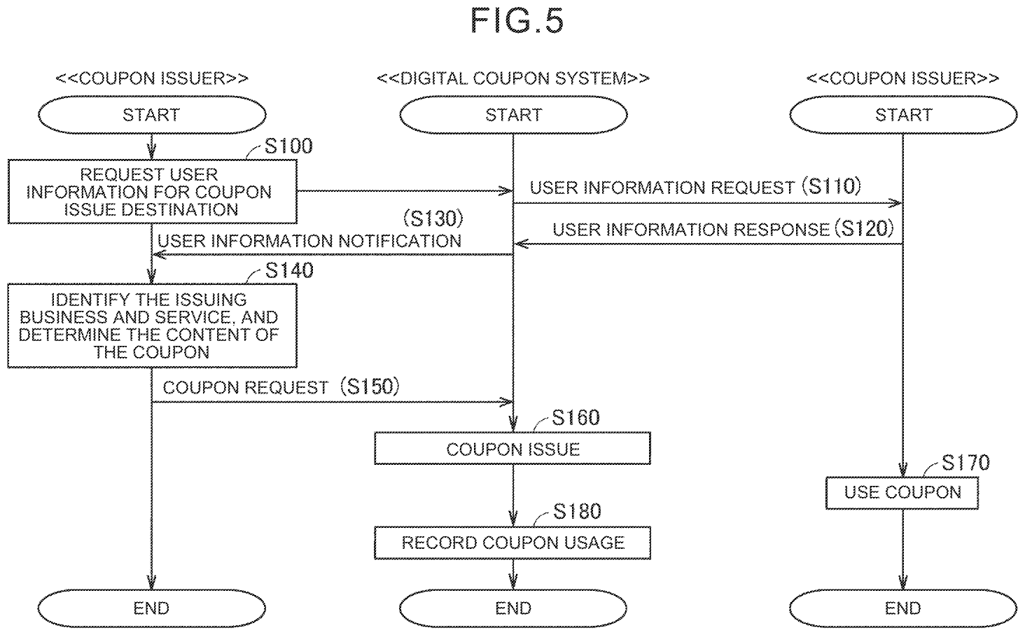

Sequence control of coupon issuance by the digital coupon system 100 will be described with reference to FIG. 5. Note that the sequence control shown in FIG. 5 is merely an example, and the present disclosure is not limited to this example.

In S100, the coupon issuer requests the digital coupon system 100 for information on the user to whom the coupon is scheduled to be issued (hereinafter referred to as user information).

The user information includes information on the user's tastes and preferences for vehicles associated with the issuer. For example, the information on tastes and preferences includes car-sharing results in the car-sharing service of the Thai division 112. The track record may be, for example, vehicle type information with many orders (requests) for car sharing. Further, the information on tastes and preferences may include vehicle type information of the vehicle owned by the user. Further, the information on tastes and preferences may include information on sales status of vehicles in the country where the user resides.
In addition, the user information includes information on features related to driving of the user's vehicle associated with the issuer. For example, the feature information includes information on routes frequently traveled by the user who is the issuing destination, information on travel speed, and the like. In addition, the characteristic information may include information such as the frequency of use of left-hand drive vehicles (or right-hand drive vehicles).
At S110, the digital coupon system 100 requests user information from the scheduled issuer based on the user information request received at S100.
At S120, the issuer transmits the user information to the digital coupon system 100 in response to the request at S110.
At S130, the digital coupon system 100 notifies the issuer of the user information received from the scheduled issuer at S120.
At S140, the issuer identifies the Thai business division and the car sharing service as issuers, and then decides to issue a coupon related to the issuer's service (car leasing service). For example, the issuer decides to issue a coupon 50 (see FIG. 6) that gives a 10% discount on the car lease fee.

It is also assumed that the user information includes information indicating that a high percentage of users use Sport Utility Vehicles (SUVs). In this case, the issuer may decide to issue a coupon 51 (see FIG. 6) that gives a 20% discount on the lease fee for the SUV vehicle. Further, the issuer may attach a message 52 (see FIG. 6) indicating that a new SUV has started to be leased to a website 500 (to be described later) from which the coupons 50 and 51 can be obtained.
At S150, the issuer requests the digital coupon system 100 to issue the coupon determined at S140.
At S160, the digital coupon system 100 (processor 10) issues the coupons (50, 51) to users associated with the issue destination in response to the coupon issuance request at S150. Specifically, the digital coupon system 100 performs processing so that each of the coupons 50 and 51 can be acquired on the website 500 shown in FIG. 6. The website 500 may be a website that can be viewed only by the user of the issue destination. For example, the user is required to enter a predetermined ID and password before browsing the website 500. The above ID and password are those given only to the user of the issue destination.

In addition, the digital coupon system 100 (processor 10) performs control to attach website URL information 53 (see FIG. 6) indicating information on the issuer to the coupons (50, 51). Specifically, the digital coupon system 100 controls posting of the URL information 53 on the website 500. Further, the URL information 53 may be displayed on the website 500 based on acquisition (use) of at least one of the coupons 50 and 51 by the user.

Referring to FIG. 5 again, at S170, the issuer user uses at least one of coupon 50 and coupon 51 issued at S160. Specifically, the issuer user can use the coupon selected on the website 500.

At S180, the digital coupon system 100 records the use of the coupon at S170. For example, the digital coupon system 100 updates coupons that have been used by the user of the issue destination to used status on the website managed by the digital coupon system 100. As a result, the business department of the issuer can confirm that the coupon has been used by browsing the website managed by the digital coupon system 100.

As described above, in the present embodiment, when the digital coupon system 100 (processor 10) receives a coupon issuance request specifying a business operator (department) and service as a coupon issuer from a coupon issuer, to issue coupons related to the service of the issuer to users associated with the issuer. This eliminates the need to directly connect the issue source system and the issue destination system each time a coupon is issued. The issuer can give the coupon to the user of the issuer simply by specifying the issuer and registering it in the digital coupon system 100. As a result, the digital coupon system 100 makes it possible to simplify cooperation between business departments.

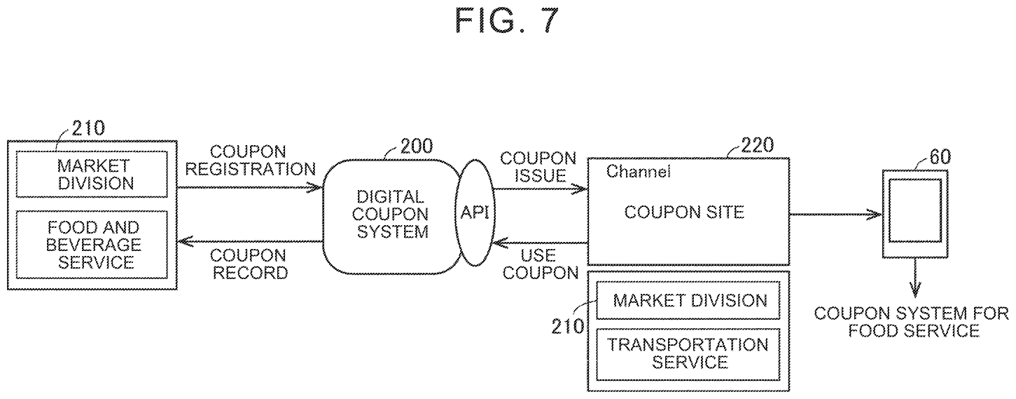

In the above-described embodiment, a plurality of business divisions that provide vehicle-related services are shown as examples, but the present disclosure is not limited to this. As shown in FIG. 7, the business department and service that issue the coupon may be the market division 210 and the food service, respectively. Also, the business department and service to which the coupon is issued may be the market division 210 and the transportation service, respectively. It should be noted that the market division 210 is an example of the “first business operator” and the “second business operator” in the present disclosure. Also, the food service and transportation service are examples of the “first service” and the “second service” of the present disclosure.

As shown in FIG. 7, the digital coupon system 200 issues coupons registered by issuers. In this case, the user associated with the issuer can access the issuer's coupon system by selecting the URL indicating the issuer's information described on the predetermined coupon site 220. The issuer user can use the coupon issued by the digital coupon system 200 by accessing the coupon system using the communication terminal 60 or the like. Note that the above URL may be set to be selectable only by the user to whom it is issued.

In the above embodiment, an example in which coupons can be used on the website 500 was shown, but the present disclosure is not limited to this. The coupon may be sent directly to the terminal of the user to whom it is issued.

In the above-described embodiment, an example is shown in which the coupon is posted on the website 500 that can be browsed only by the user associated with the coupon issuer, but the present disclosure is not limited to this. For example, the coupon may be posted on a coupon site that can be browsed by general users. In this case, the coupon may be set to be usable only by users associated with the issuer of the coupon.

For example, when a coupon is selected on the coupon site, an input form is displayed requesting input of user information (ID, password, etc.) of the user associated with the issuer. The issue destination server inquires about the user information entered in the input form. When the issue destination server confirms that the input user information is registered user information, it transmits an authorization signal to the coupon site server. The coupon site server permits the use of the coupon based on the permission signal.

In the above-described embodiment, an example is shown in which user information about a coupon-issuing destination is requested before a coupon-issuing business operator and service are identified, but the present disclosure is not limited to this. For example, the user information may be requested after the coupon issuance request is made by specifying the business operator and service to which the coupon is to be issued. In this case, the coupon issuance request is updated based on the user information. That is, the second coupon issuance request is made.

The embodiment disclosed herein should be considered to be exemplary and not restrictive in all respects. The scope of the present disclosure is shown by the scope of claims rather than the description of the above embodiments, and is intended to include all modifications within the meaning and the scope equivalent to the scope of claims.

What is claimed is:

1. An information processing device that manages a coupon related to a service provided by each of a plurality of business operators, the information processing device comprising:
a database that stores, for each of the business operators, information about the business operator and information about the service provided by the business operator in an associated manner; and
a control unit that performs control to issue the coupon in response to a coupon issuance request from each of the business operators, wherein:
the business operators include a first business operator that provides a first service and a second business operator that provides a second service; and
when the control unit receives, from the first business operator, the coupon issuance request that specifies the second business operator and the second service as a coupon issuance target related to the first service, the control unit performs control to issue the coupon related to the first service to a user associated with the issuance target.

2. The information processing device according to claim 1, wherein the control unit performs control to acquire user information about the user; and before issuing the coupon issuance request, performs control to notify the first business operator of the user information.

3. The information processing device according to claim 2, wherein:
each of the business operators provides a vehicle-related service; and
the user information includes either or both of: a taste and preference of the user regarding a vehicle; and a characteristic of the user regarding vehicle driving.

4. The information processing device according to claim 1, wherein the control unit performs control to attach uniform resource locator information of a website indicating information about the first business operator to the coupon.

5. The information processing device according to claim 1, wherein the control unit performs control to issue the coupon to the user associated with the issuance target when the first business operator and the second business operator are the same.
